(19) United States
(12) Patent Application Publication
(10) Pub. No.: US 2022/0140911 A1
(43) Pub. Date: May 5, 2022

(54) BI-DIRECTIONAL SIGNAL INTERFACE WITH SUPPRESSION OF REFLECTED SIGNALS

(71) Applicant: Photonic Systems, Inc., Billerica, MA (US)

(72) Inventors: Edward I. Ackerman, Needham, MA (US); Charles H. Cox, Carlisle, MA (US)

(73) Assignee: Photonic Systems, Inc., Billerica, MA (US)

(21) Appl. No.: 17/510,464

(22) Filed: Oct. 26, 2021

Related U.S. Application Data
(60) Provisional application No. 63/108,304, filed on Oct. 31, 2020.

(51) Int. Cl. H04B 10/50; H04B 10/69; H01Q 21/24; G02F 1/21; G02F 1/03; G02F 1/015

(52) U.S. Cl. CPC H04B 10/505; H04B 10/69; H01Q 21/24; G02F 2202/20; G02F 1/03; G02F 1/015; G02F 1/212

(57) ABSTRACT

A bi-directional signal interface includes a first and second port configured to pass transmit RF signals and receive RF signals. A MZI includes a first traveling wave electrode connected to the first bidirectional signal port and a second traveling wave electrode connected to the second bidirectional signal port. A coupler has an input connected to a transmit input port, a first output connected to the first traveling wave electrode, and a second output connected to a second end of the second traveling wave electrode. A laser provides an optical signal to the MZI. An optical filter is coupled to an output of the MZI and preserves the optical carrier and the modulation sideband at the second frequency and rejects the modulation sideband at the first frequency. A detector converts light received from the filter to the receive RF signal and a suppressed level of the transmit RF signal.

### CROSS REFERENCE TO RELATED APPLICATIONS

The present application is a non-provisional application of U.S. Provisional Patent Application No. 63/108,304, entitled “Bi-Directional Signal Interface with Suppression of Reflected Signals” filed on Oct. 31, 2020. The entire contents of U.S. Provisional Patent Application No. 63/108,304 are herein incorporated by reference.

### INTRODUCTION

The growing demand for higher data rates to enable new broadband media applications and services has spurred increased research into full-duplex system architectures, which can effectively double the information capacity of wireless communication systems.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1A shows a communication link with two antennas being used in a conventional manner.

FIG. 1B shows measured S-parameters of the two intended signal paths, that is S₂₁ and S₃₄, for an antenna link in an anechoic chamber.

FIG. 1C illustrates measured S-parameters showing the “leakage” of transmitted signals into the receivers at each end of the communication link characterized by the parameters S₃₁ and S₂₄.

FIG. 2A shows a bi-directional signal interface with one of the antennas in the communication link of FIG. 1A connected to a bi-directional interface of the present teaching that is designed to mitigate the effect of the reflections that limited the achievable Tx/Rx isolation of the interface in FIG. 1A to only −20 dB.

FIG. 2B illustrates the measured S-parameters of the two intended signal paths, that is, S₂₁ and S₃₄.

FIG. 2C shows the measured “leakage” of signals into unintended paths.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

The RF front end of a broadband full-duplex communication architecture is described, in which a single antenna simultaneously transmits and receives signals that can overlap spectrally to any degree. This architecture not only minimizes the power of the transmitted signal at the receiver in the ideal and purely hypothetical case in which the antenna has infinite return loss, but also successfully suppresses the portion of the transmitted signal reflected off of an actual antenna while successfully recovering received signals at the same frequency. The hardware that enables the transmit signal that is reflected from the antenna to be separated from a same-frequency signal received by that antenna performs this separation purely in the analog domain without the need for a control circuit or any other digital-domain hardware. Known antenna interfaces do not distinguish the reflected transmit signal from a same-frequency receive signal in the analog domain. Using this antenna interface, it has been demonstrated that single-antenna full-duplex capability with better than −30 dB of analog transmit/receive isolation nearly everywhere in the 1-18 GHz band can be achieved. In any sub-band within this 17 GHz-wide instantaneous bandwidth, additional analog and digital techniques can be applied to further improve the transmit/receive isolation. See, for example, K. Kolodziej, B. Perry, and J. Herd, “In-Band Full-Duplex Technology: Techniques and Systems Survey,” IEEE Trans. Microwave Theory Tech., vol. 67, pp. 3025-3041, July 2019).

To enable single-antenna full-duplex, a commonly employed method of achieving the necessary bi-directional interface to the antenna is to use a three-port device known as a circulator. This is typically a passive component with three ports arranged in a waveguide ring around a ferrite disc that induces a direction-dependent phase shift, causing the two counter-circulating halves of an input signal to add up constructively at the next port in one circumferential direction along the ring but destructively at the next port in the opposite direction. The fact that they suppress the undesired signal in this way, that is using two paths designed to differ in electrical length by 180° at a certain frequency, inherently limits the operational bandwidth over which ferrite circulators can isolate the receive-signal port from the transmit-signal port. This is true even when the bi-directional signal port is connected to an “ideal” 50-Ω load, such as one of the ports of a calibrated network analyzer.

The ferrite circulator's unimpressive combination of transmit/receive (Tx/Rx) isolation and bandwidth, which typically is no better than −20 dB over bandwidths of only one octave or less, has motivated research into bi-directional interfaces with improved isolation over broader bandwidths. For example, one analog approach that leverages the inherently broadband (from a radio-frequency perspective) of photonics technology has demonstrated Tx/Rx isolation of better than −40 dB across three decades of bandwidth from 20 MHz to 20 GHz when the interface's bi-directional port is terminated in 50Ω. See, for example, C. Cox and E. Ackerman, “Maximizing RF Spectrum Utilization with Simultaneous Transmit and Receive,” Microwave J., pp. 114-126, September 2014. When an actual antenna replaces the 50-Ω load at the bi-directional port in any such interface, such impressive Tx/Rx isolation has not been possible across such bandwidths, at least in part, because no antenna exists with similarly impressive return loss across such bandwidths. In fact, it is rare to find an antenna with a combination of return loss and bandwidth that is any better than the combination of Tx/Rx isolation and bandwidth mentioned above for ferrite circulators, that is, no better than −20 dB across no more than one octave.

One method that has been employed by some researchers to mitigate the effect of reflections off of the antenna in single-antenna full-duplex systems is to tap off a portion of the transmit signal prior to the interface and to adjust, for example, using a vector modulator, the amplitude and phase of this “reference copy” of the transmit signal prior to a point just before the receiver front-end where it can be combined with the signal in the receive path. When this amplitude and phase adjustment is performed perfectly, the vector-modulated reference copy of the transmit signal subtracted from the antenna-reflected copy of the transmit signal results in perfect transmit signal cancellation at the receiver. In practice, however, an attractive degree of cancellation can only be achieved over a limited bandwidth, and therefore architectures that employ this method include control circuits that modify the settings to the vector modulator as a function of the transmit signal frequency to enable a large degree of cancellation over just the instantaneous bandwidth of that transmit signal. A recent example of such an architecture achieved Tx/Rx isolation of better than −40 dB across a tunable band 30 MHz in width. See, for example, C. Campbell, J. Lovseth, S. Warren, A. Weeks, and P. Schmid, “A BST Varactor Based Circulator Self-Interference Canceller for Full Duplex Transmit Receive Systems,” Proc. IEEE Int. Microwave Symp. Dig., pp. 1195-1198, August 2020.

The present teaching relates to an analog-domain bi-directional interface that, when connected to an actual transmitting and receiving antenna, separates the transmit signal that reflects off of the antenna from the receive signal rather than attempting to perform cancellation by subtracting a reference copy of the transmit signal.

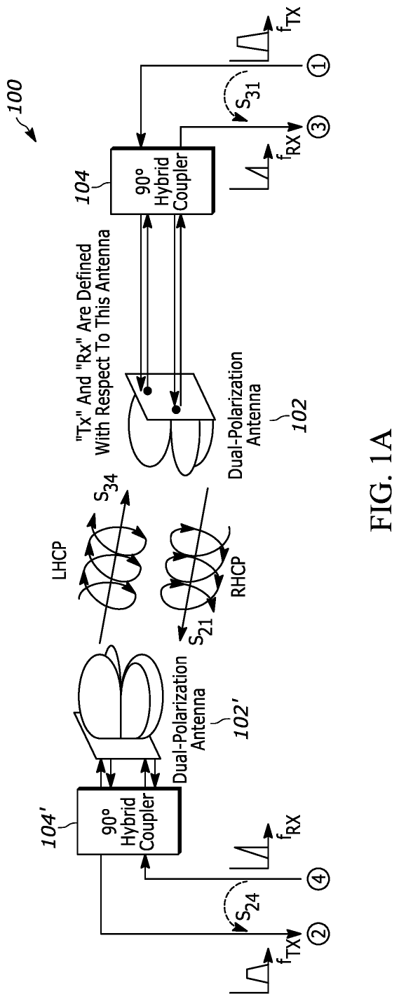

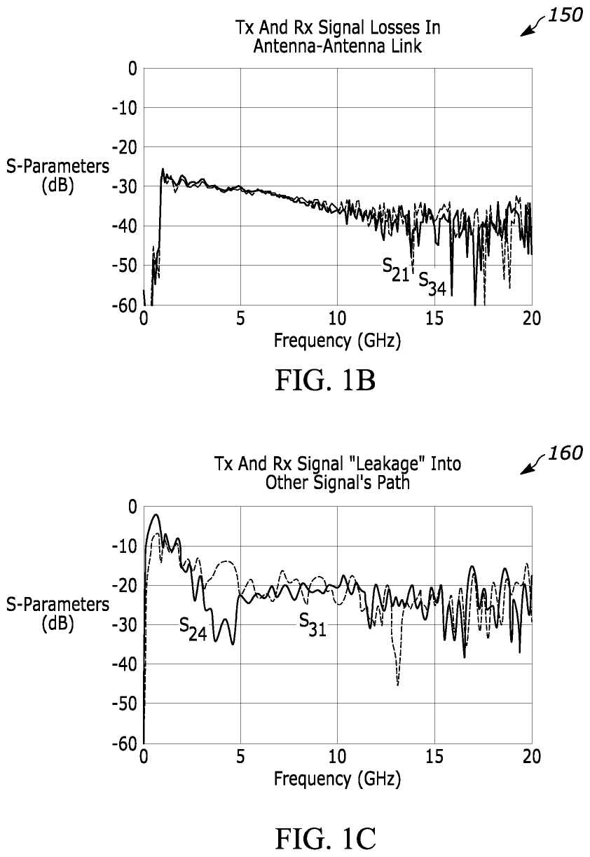

The approach as described herein involves the use of an antenna that has two waveguide ports which enable it to transmit signals with either linear or circular polarization depending on the difference in phase between the components of a signal supplied to these two ports. FIG. 1A shows a communication link 100 including two antennas 102, 102′ being used in a conventional manner, that is without application of the present teaching. The communication link 100 communicates signals in two directions simultaneously using the two opposite directions of circular polarization, with the antenna 102 transmitting a signal having right-hand circular polarization (RHCP) and receiving a signal having left-hand circular polarization (LHCP).

A communication link between two such antennas 102, 102′, separated by approximately 10 feet, was assembled within an anechoic chamber by connecting 90° hybrid couplers 104, 104′ as shown in FIG. 1A to produce the desired RHCP and LHCP signals. The antennas 102, 102′ and couplers 104, 104′ used in this communication link were selected for optimum performance in the 1-18 GHz band.

Communication between the two antennas 102, 102′ that are both transmitting and receiving results in a four-port network that can be characterized using S-parameters. With the ports numbered as shown in FIG. 1A, the intended signal paths are characterized by the parameters S₂₁ and S₃₄.

FIG. 1B shows measured S-parameter data 150 of the two intended signal paths, that is S₂₁ and S₃₄, for an antenna link in an anechoic chamber. The “leakage” of transmitted signals into the receivers at each end of the communication link is characterized by the parameters S₃₁ and S₂₄. FIG. 1C is a data plot 160 of the measured S-parameters. For a system as uncomplicated as this one, these parameters are effectively the “Tx/Rx isolation” at each of the communications link. In other words, this is the degree to which a signal being supplied for one of the antennas to be transmitted is suppressed at the receiver connected to that antenna. For the antenna 102 shown in FIG. 1A, for example, S₃₁ is the Tx/Rx isolation.

The two-polarization antennas used in the antenna chamber set-up were selected for their low cross-port isolation of −35 dB, but the advertised worst-case return losses of their individual waveguide ports were in the neighborhood of only −14 dB, and the isolation of the 90° hybrid coupler was quoted at only −17 dB. FIG. 1C illustrates the measured Tx/Rx isolation is therefore limited by these components, but it is better than −14 dB at all frequencies and much better than this worst-case value at many frequencies.

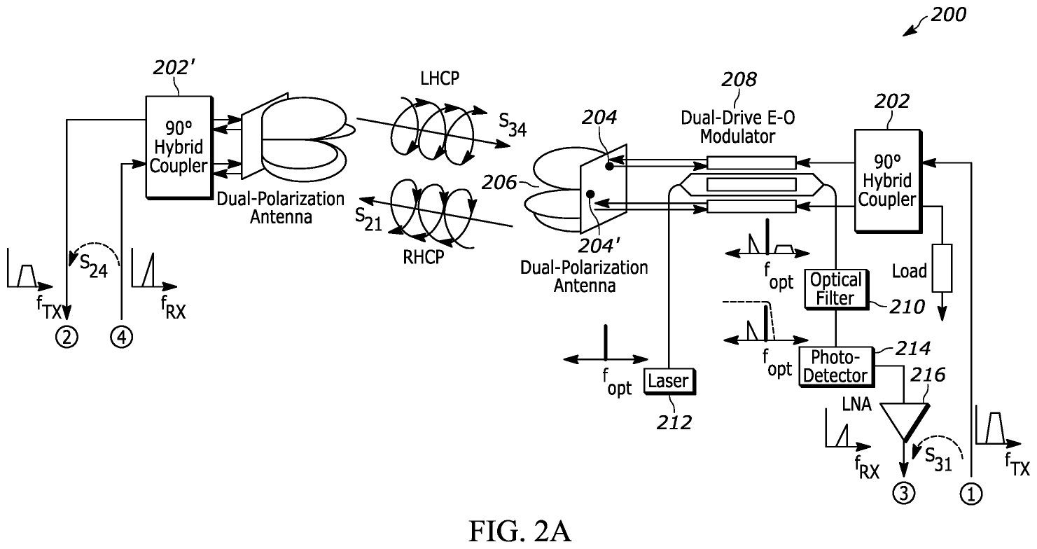

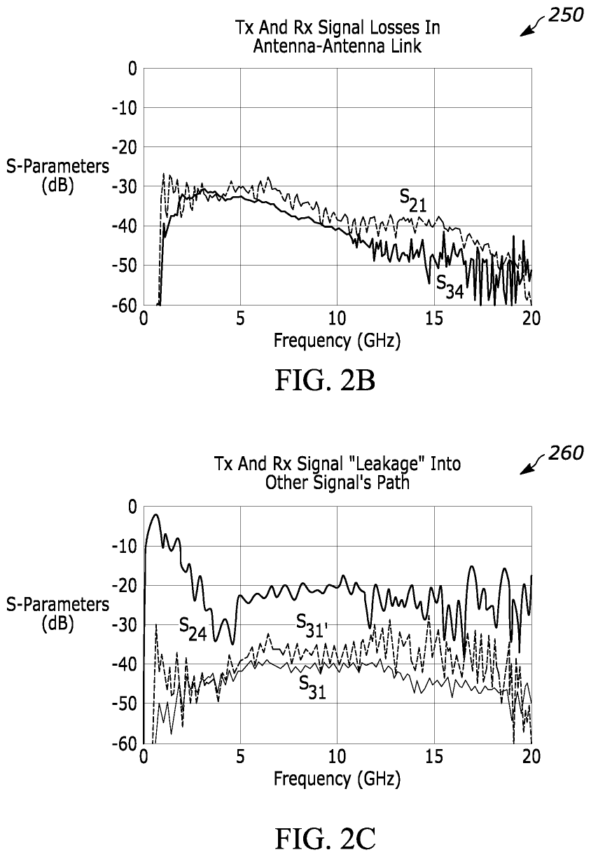

FIG. 2A shows a bi-directional signal interface 200 including one of the antennas in the communication link of FIG. 1A connected to form a bi-directional interface according to the present teaching that is designed to mitigate the effect of the reflections that limited the achievable Tx/Rx isolation of the interface in FIG. 1A to only −20 dB. In this bi-directional signal interface 200, between the necessary 90° coupler 202 and the two waveguide ports 204, 204′ of the two-polarization antenna 206, are the two traveling-wave electrodes of a dual-drive electro-optic modulator 208 of the Mach-Zehnder interferometer (MZI) interferometric variety.

In operation, light from a laser 212 at the optical frequency fₒₚₜ is supplied to this modulator 208 from the end of the device that causes the light to co-propagate with RF signals received by the antenna 206 so that these signals modulate the light with maximum efficiency. The RF signals to be transmitted by the antenna 206 propagate on the modulator electrodes of the modulator 208 in the opposite direction, causing them to modulate the light much less efficiently. Moreover, a 90° difference in RF phase between the receive-signal waves on the MZ modulator's two drive electrodes causes the receive signal to impose only one modulation sideband on the optical carrier at frequencies fₒₚₜ−f_{RX}, and a 90° difference of the opposite sign between the transmit-signal waves on the two drive electrodes imposes the transmit signal on the other modulation sideband at frequencies fₒₚₜ+f_{TX}, as shown by the spectral diagram just below the modulator in FIG. 2A. Supplying signals to the two drive electrodes of a dual-drive MZ modulator 208 through a 90° hybrid coupler 202 is a generally known technique for achieving single-sideband modulation of an optical carrier. See, for example, G. Smith, D. Novak, and Z. Ahmed, “Overcoming Chromatic-Dispersion Effects in Fiber-Wireless Systems Incorporating External Modulators,” IEEE Trans. Microwave Theory Tech., vol. 45, pp. 1410-1415, August 1997. But is known only to the extent that one modulation signal is fed to the modulator 208, and from only one end of its electrodes.

One feature of the architecture shown in FIG. 2A is that, even when the transmit and receive signals include exactly the same frequencies, they are made to modulate the optical carrier in completely distinct portions of the optical spectrum. It is, therefore, possible to insert between the modulator 208 and photodetector 214 an optical filter 210 that preserves the optical carrier and the modulation sideband imposed by the receive signal while rejecting the modulation sideband imposed by the transmit signal. This feature was investigated theoretically in 2016. See P. Devgan, “Isolation of RF Signals Using Optical Single Side Band Modulation Combined with Optical Filtering,” U.S. Pat. No. 9,240,842, issued Jan. 19, 2016. This feature was also demonstrated experimentally in 2019 using hardware intended to enable a bi-directional interface to an antenna having a single waveguide port that can only transmit and receive in a single polarization, as is described further below. See, E. Ackerman, C. Cox, H. Roussell, and P. Devgan, “Broadband Simultaneous Transmit and Receive from a Single Antenna using Improved Photonic Architecture,” Proc. Int. Microwave Symp. Digest, June 2019.

Another feature of the present teaching that can be illustrated in the architecture shown in FIG. 2A is that if care is taken to equalize the loss and delay in the cables or other waveguides that connect the MZ modulator's two drive electrodes to the antenna's two waveguide ports of the modulator 208, and if each source of a reflection in one of these connections has a parallel reflection of equal amplitude and phase in the second of these connections, then the two reflected transmit signal components should maintain the 90° phase difference imposed by the hybrid coupler 202, causing even the reflected transmit signals to modulate only the optical sideband that is rejected by the optical filter. Therefore, unlike in the bi-directional interface of FIG. 1A, the Tx/Rx isolation achievable using the bi-directional interface described in connection with FIG. 2A should not be limited by the transmit-signal reflections (which, at some frequencies, were as great as −14 dB).

A laser 212, such as a semiconductor diode laser, the dual-drive MZ modulator 208 with electrode access from both ends, optical bandpass filter 210, and p-i-n photodiode detector 214 were connected in the anechoic chamber to the antenna ports 204, 204′ and 90° hybrid coupler ports 202 as shown in FIG. 2A to realize the bi-directional interface of the present teaching.

Also included as shown in FIG. 2A was a low-noise amplifier (LNA) 216 following the photodetector 214, which compensated for about 20 dB of RF loss in the modulator-photodetector link at low frequencies. This was done only to facilitate analysis. Eliminating this low-noise amplifier (LNA) 216 would not alter conclusions drawn from the measured data, as is made clear below.

For the bi-directional interface described in connection with FIG. 2A, measured data are presented. FIGS. 2B and 2C show plots 250, 260 of the same four measured S-parameters that were plotted in FIGS. 1B and 1C for the interface of FIG. 1A. FIG. 2B illustrates the measured S-parameters of the two intended signal paths—i.e., S₂₁ and S₃₄. Though these do not differ dramatically from the corresponding S₂₁ and S₃₄ for the architecture described in connection with FIG. 1 (i.e., compared to curves in FIG. 1B), it is important to understand what differences do exist. For the bi-directional signal interface described in connection with FIG. 2A, the transmit signal suffers slightly more loss, especially at high frequencies, than it does in the signal interface described in connection with the signal interface described in connection with FIG. 1A because it has to traverse the electrodes of the modulator 208 between the input 90° hybrid coupler and the two waveguide ports of the antenna 206. In other words, S₂₁ is lower (worse) in FIG. 2A than in FIG. 1A, but only slightly so at most frequencies.

Furthermore, for the interface described in connection with FIG. 2A, the receive signal suffers slightly more loss—especially at high frequencies—than it does in the signal interface FIG. 1A. In other words, S₃₄ is lower (i.e., worse) in signal interface described in connection with FIG. 2B than the signal interface described in connection with FIG. 1B at the higher frequencies. This is because, although the lower noise amplifier's 216 post-amplifier gain compensates for the photonic link loss at low frequencies, its gain is relatively constant vs. frequency compared to that of the photonic link and, therefore, it does not compensate fully for the greater insertion loss of the photonic link loss at higher frequencies.

For the bi-directional interface of FIG. 2A, the measured “leakage” of signals into unintended paths is shown in FIG. 2C. Here S₂₄, the leakage of the signal to be transmitted by the antenna 202′ into that antenna's receive signal path, remains unchanged by the reconfiguration of the bi-directional interface to the antenna 202, as expected. In marked contrast, however, S₃₁, which is the leakage of the signal to be transmitted by the antenna 202 into that antenna's receive signal path, does change dramatically. Two S₃₁ curves are shown in FIG. 2C. The dashed line is literally that S-parameter itself, which is the measured portion of the signal from port 1 that reaches port 3. For the hardware configuration shown in FIG. 2A, however, it would not be “fair” to call S₃₁ the Tx/Rx isolation, because at the higher frequencies the combination of the photonic link and post-amplifier is attenuating all signals. That is, attenuating not only the transmit signal but also the receive signal to a greater degree than it is in the 2-3 GHz band where the post-amplifier gain exactly compensates for the link loss. It would not be appropriate to lump this additional signal loss at high frequencies in with the Tx/Rx isolation, which ought to be a measure of the degree to which the interface favors the delivery of receive signals to the receiver over the undesired delivery of transmit signals to the receiver. The S₃₁′ curve in FIG. 2C “penalizes” the measured curve for the additional loss of this photonic path at high frequencies by adding a correction factor to S₃₁ that is equal to the parameter S₃₄ from FIG. 1B minus the parameter S₃₄ from FIG. 2B.

The benefit imparted by the bi-directional interface of FIG. 2A is clear. The Tx/Rx isolation S₃₁′ plotted in FIG. 2C is at least 10 dB better (i.e., further from 0 dB) than the Tx/Rx isolation S₃₁ plotted in FIG. 1C for the architecture of FIG. 1A. As explained previously, the Tx/Rx isolation S₃₁ of the FIG. 1C interface had been limited to values as poor as −14 dB at some frequencies by the return loss and isolation characteristics of the antenna 206 and hybrid coupler 202.

By contrast, the plot shown in FIG. 2C of the Tx/Rx isolation S₃₁′ for the bi-directional signal interface of FIG. 2A shows that these device characteristics no longer impose the same limits. First, it is clear from the configuration shown in FIG. 2A that the 90° hybrid coupler no longer provides a path through which the transmit signal can reach the receiver. Second, to the degree that portions of the transmit signals reflected off of the two waveguide ports of the antenna remain 90° out-of-phase, the interface of FIG. 2C causes these reflected transmit signals to occupy only the modulation sideband of the optical carrier that is rejected by the optical bandpass filter. The net results of these design features is that the analog interface to the right-hand antenna in FIG. 2A enables full-duplex communications using this antenna with Tx/Rx isolation better than −30 dB at nearly every frequency in an instantaneous bandwidth of 17 GHz (=18 GHz−1 GHz). Application of additional analog and/or digital techniques in narrow sub-bands within this wide instantaneous bandwidth can further improve the Tx/Rx isolation, if desired.

### Equivalents

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. A bi-directional signal interface comprising:
a) a first bidirectional signal port configured to be connected to a first antenna port and configured to pass a transmit RF signal and a receive RF signal having a same frequency at a same time;
b) a second bidirectional signal port configured to be connected to a second antenna port and configured to pass the transmit RF signal and the receive RF signal having the same frequency at the same time;
c) a dual-drive Mach-Zehnder electro-optic modulator comprising a first traveling-wave electrode having a first end electrically coupled to the first bidirectional signal port and a second traveling-wave electrode having a first end electrically coupled to the second bidirectional signal port;
d) a coupler having a first input connected to a transmit input port that passes the RF transmit signal, a first output connected to a second end of the first traveling wave electrode and a second output connected to a second end of the second traveling wave electrode;
e) a laser configured to provide an optical signal comprising an optical carrier to an optical input of the dual-drive Mach-Zehnder electro-optic modulator so that the optical signal co-propagates with the receive RF signal such that receive RF signal imposes a modulation sideband on the optical carrier at a first frequency and so that the optical signal counter propagates with the transmit RF signal such that the transmit RF signal imposes a modulation sideband on the optical carrier at a second frequency that is distinct from the first frequency;
f) an optical filter having an input coupled to an output of the dual-drive Mach-Zehnder electro-optic modulator and configured to preserve the optical carrier and the modulation sideband at the second frequency and to reject the modulation sideband at the first frequency; and
g) an optical detector positioned to receive light from an output of the optical filter, the optical detector generating an electrical signal comprising the receive RF signal and a suppressed level of the transmit RF signal at a receive output of the bidirectional interface.

2. The bi-directional signal interface of claim 1 wherein the coupler further comprises a second input that is electrically connected to a load.

3. The bi-directional signal interface of claim 1 wherein the coupler comprises a ninety-degree coupler.

4. The bi-directional signal interface of claim 1 further comprising a low-noise amplifier that is electrically connected between the optical detector and the receive output of the bidirectional interface.

5. The bi-directional signal interface of claim 1 wherein the dual-drive Mach-Zehnder electro-optic modulator comprises a lithium-niobate electro-optic modulator.

6. The bi-directional signal interface of claim 1 wherein the dual-drive Mach-Zehnder electro-optic modulator comprises a semiconductor electro-optic modulator.

7. The bi-directional signal interface of claim 1 wherein the laser comprises a diode laser.

8. The bi-directional signal interface of claim 1 wherein a first difference in phase between signals at the first antenna port and the second antenna port corresponds to a first transmit or receive signal polarization, and a second difference in phase between signals at the first antenna port and the second antenna port correspond to a second transmit or receive signal polarization that is orthogonal to the first transmit or receive signal polarization.

9. The bi-directional signal interface of claim 1 wherein the bi-directional signal interface is configured so that a ratio of the suppressed level of the transmit RF signal to the receive RF signal in the electrical signal is less than −30 dB.

10. The bi-directional signal interface of claim 1 wherein the bi-directional signal interface is configured so that the ratio of the suppressed level of the transmit RF signal to the receive RF signal in the electrical signal is less than −30 dB over an RF bandwidth of at least 17 GHz.

11. A method of interfacing a bidirectional signal, the method comprising:
a) receiving a receive RF signal at an antenna having a first and a second port;
b) propagating the receive RF signal along a first traveling-wave electrode of a dual-drive Mach-Zehnder electro-optic modulator from a first end;
c) propagating the receive RF signal along a second traveling-wave electrode of the dual-drive Mach-Zehnder electro-optic modulator from a first end;
d) propagating a transmit RF signal along the first traveling-wave electrode of the dual-drive Mach-Zehnder electro-optic modulator from a second end, the transmit RF signal and the receive RF signal having a same frequency at a same time;
e) propagating a 90-degree phase shifted version of the transmit RF signal along the second traveling-wave electrode of the dual-drive Mach-Zehnder electro-optic modulator from a second end;
f) co-propagating an optical signal comprising an optical carrier with the propagating receive RF signals along the first and second traveling-wave electrodes such that receive RF signal imposes a modulation sideband on the optical carrier at a first frequency;
g) counter propagating the optical signal comprising the optical carrier with the propagating transmit RF signal such that the transmit RF signal imposes a modulation sideband on the optical carrier at a second frequency that is distinct from the first frequency;
h) optically filtering the propagated optical signal to preserve the optical carrier and the modulation sideband at the second frequency and to reject the modulation sideband at the first frequency; and
i) detecting the filtered propagated optical signal to generate an electrical signal comprising the receive RF signal and a suppressed level of the transmit RF signal.

12. The method of interfacing a bidirectional signal of claim 11 wherein a difference in phase between signals at the first and second ports of the antenna corresponds to a first signal polarization and a second difference in phase between signals at the first and second ports of the antenna corresponds to a second signal polarization.

13. The method of interfacing a bidirectional signal of claim 12 further comprising applying the received receive RF signal from the first port to the first traveling-wave electrode of the dual-drive Mach-Zehnder electro-optic modulator first and then applying the received receive RF signal from the second port to the second traveling-wave electrode of the dual-drive Mach-Zehnder electro-optic modulator.

14. The method of interfacing a bidirectional signal of claim 13 wherein the applying the received receive RF signal from the first port to the first traveling-wave electrode of the dual-drive Mach-Zehnder electro-optic modulator first and then applying the received receive RF signal from the second port to the second traveling-wave electrode of the dual-drive Mach-Zehnder electro-optic modulator comprises equalizing delays between the propagating receive RF signals.

15. The method of interfacing a bidirectional signal of claim 13 wherein the applying the received receive RF signal from the first port to the first traveling-wave electrode of the dual-drive Mach-Zehnder electro-optic modulator first and then applying the received receive RF signal from the second port to the second traveling-wave electrode of the dual-drive Mach-Zehnder electro-optic modulator comprises equalizing losses of the applications.
